(19) United States
(12) Patent Application Publication
(10) Pub. No.: US 2020/0402372 A1
(43) Pub. Date: Dec. 24, 2020

(54) ALARM APPARATUS AND ALARM METHOD

(71) Applicant: ATake Digital Technology (Shenzhen) Co., Ltd., shenzhen (CN)

(72) Inventor: Kuo-tsai LEE, shenzhen (CN)

(21) Appl. No.: 16/524,099

(22) Filed: Jul. 28, 2019

(30) Foreign Application Priority Data
Jun. 24, 2019 (CN) 201910559410.2

(51) Int. Cl. G08B 5/36; G08B 3/10; G08B 7/06; G08B 17/10; G08B 17/12

(52) U.S. Cl. CPC G08B 5/36; G08B 3/1008; F21Y 2115/10; G08B 17/10; G08B 17/12; G08B 7/064

(57) ABSTRACT

The present disclosure provides an alarm, which includes a fixing member and a folding member. The fixing member includes a plurality of transmitters and at least one luminaire. Each transmitter is configured to detect an environment where the transmitter is located, and transmit a detecting signal. The luminaire includes a speaker, a receiver, and a LED lamp. The speaker and the LED lamp are both electrically connected to the receiver, the receiver is configured to receive the detecting signal and control on/off of the LED lamp, and/or control the speaker to raise an alarm.

### TECHNICAL FIELD

The present disclosure relates to the technical field of security equipment, and more particularly relates to an alarm apparatus and an alarm method.

### BACKGROUND

Most of the doorbells on the market have single function, i.e., making a sound, which cannot meet a higher requirement of people. For example, an alarm apparatus that only makes sound is useless for people of hearing impairment

### SUMMARY

It is therefore one main objective of the disclosure to provide an alarm apparatus with multi-function.

In order to realize the objective, the present disclosure provides an alarm apparatus, which includes:

a plurality of transmitters, each transmitter is configured to detect an environment where the transmitter is located, and transmit a detecting signal; and

at least one luminaire, including a speaker, a receiver, and a LED lamp;

the speaker and the LED lamp are both electrically connected to the receiver, the receiver is configured to receive the detecting signal, and control on/off of the LED lamp, and/or control the speaker to raise an alarm.

In one embodiment, the receiver includes:

a micro-controller, electrically connected to the LED lamp;

a signal receiving module;

a signal converting module, electrically connected to the micro-controller and the signal receiving module, respectively; and

a voice module, electrically connected to the speaker and the micro-controller, respectively.

In one embodiment, the signal converting module includes:

a signal demodulating unit, electrically connected to the signal receiving module; and

a signal processing unit, electrically connected to the signal demodulating unit and the micro-controller, respectively.

In one embodiment, the luminaire includes:

an upper housing, an end of the upper housing defines an opening;

a control panel, the micro-controller, the voice module, the LED lamp, the signal receiving module, and the signal converting module are all encapsulated on the control panel; and

a lampshade, disposed at a periphery of the opening of the upper housing, and the speaker is defined in the upper housing.

In one embodiment, the luminaire further includes a toggle switch embedded in the upper housing, and the LED lamp is connected to a mains supply through the toggle switch.

In one embodiment, the luminaire further includes:

an adjusting button embedded in the upper housing and electrically connected to the micro-controller.

In one embodiment, an alternating current plug is embedded in an end of the upper housing away from the lampshade, and the luminaire further includes:

a protecting cover, defined at the end of the upper housing away from the lampshade and covering the alternating current plug, the protective cover is electrically connected to the alternating current plug.

The present disclosure further provides an alarm method, including:

receiving an alarm signal sent by a transmitter in real time or periodically; and

turning on or turning off of a LED lamp, and/or controlling a speaker to raise an alarm, according to the alarm signal.

In one embodiment, before the operation of turning on or turning off of a LED lamp, and/or controlling a speaker to raise an alarm, according to the alarm signal, the alarm method further includes:

decoding an code ID according to the alarm signal;

comparing the code ID with a preset code ID; and

turning on or turning off of the LED lamp, and/or controlling the speaker to raise the alarm based on the alarm signal, when the code ID matches the preset code ID.

In one embodiment, the operation of turning on or turning off of a LED lamp, and/or controlling a speaker to raise an alarm, according to the alarm signal, includes:

acquiring a type of an alarm sound, and/or a color type of light, and/or a flashing frequency corresponding to the alarm signal, according to a relationship between a type of a preset alarm signal and at least one parameter selected from a group consisting of the type of the alarm sound, the color type of light, and the flashing frequency, when the alarm signal is received; and

controlling the speaker to raise the alarm according to the type of the alarm sound, and/or controlling the LED lamp to flash according to the color type of light and/or flashing frequency.

In the technical solution of the present disclosure, the plurality of transmitters can be respectively defined on the doorbell and the window, and defined in the kitchen and factory. Each transmitter is configured to detect the environment where the transmitter is located, and transmit the detecting signal. The luminaire is internally provided with the speaker, the receiver, and the LED lamp. The receiver is configured to receive the detecting signal. The transmitter can send out the detecting signal when some one triggers the transmitter on the doorbell or there is a gas leak. The receiver in the house or monitoring room controls the luminaire to emit light with different colors, and/or turns on or turns off the luminaire, and/or controls the speaker to issue the alarm, after the receiver receives the detecting signal sent by the transmitter. The alarm can be either a buzzing or a music. Therefore, the alarm apparatus of the present disclosure can meet the needs of different people.

### BRIEF DESCRIPTION OF THE DRAWINGS

To illustrate the technical solutions according to the embodiments of the present disclosure or in the prior art more clearly, the accompanying drawings for describing the embodiments or the prior art are introduced briefly in the following. Apparently, the accompanying drawings in the following description are only about some embodiments of the present disclosure, and persons of ordinary skill in the art can derive other drawings from the accompanying drawings without creative efforts.

FIG. 1 is a schematic diagram showing an internal system module of an alarm apparatus according to an exemplary embodiment of the present disclosure;

FIG. 2 is a schematic structural diagram of an alarm apparatus according to an exemplary embodiment of the present disclosure;

FIG. 3 is a schematic exploded diagram of the alarm apparatus according to an exemplary embodiment of the present disclosure.

### LABELS ILLUSTRATION FOR DRAWINGS

| Label | Name | Label | Name |
|---|---|---|---|
| 10 | upper housing | 11 | speaker |
| 12 | LED lamp | 13 | control panel |
| 14 | lampshade | 15 | toggle switch |
| 16 | adjusting button | 17 | AC plug |
| 18 | protecting cover | | |

The realization of the aim, functional characteristics, advantages of the present disclosure are further described specifically with reference to the accompanying drawings and embodiments.

### DETAILED DESCRIPTION

The technical solutions of the embodiments of the present disclosure will be clearly and completely described in the following with reference to the accompanying drawings. It is obvious that the embodiments to be described are only a part rather than all of the embodiments of the present disclosure. All other embodiments obtained by persons skilled in the art based on the embodiments of the present disclosure without creative efforts shall fall within the protection scope of the present disclosure.

It is to be understood that, all of the directional instructions in the exemplary embodiments of the present disclosure (such as top, down, left, right, front, back) can only be used for explaining relative position relations, moving condition of the elements under a special form (referring to figures), and so on, if the special form changes, the directional instructions changes accordingly.

In addition, the descriptions, such as the “first”, the “second” in the present disclosure, can only be used for describing the aim of description, and cannot be understood as indicating or suggestting relative importance or impliedly indicating the number of the indicated technical character. Therefore, the character indicated by the “first”, the “second” can express or impliedly include at least one character. In addition, the technical proposal of each exemplary embodiment can be combined with each other, however the technical proposal must base on that the ordinary skill in that art can realize the technical proposal, when the combination of the technical proposals occurs contradiction or cannot realize, it should consider that the combination of the technical proposals does not existed, and is not contained in the protection scope required by the present disclosure.

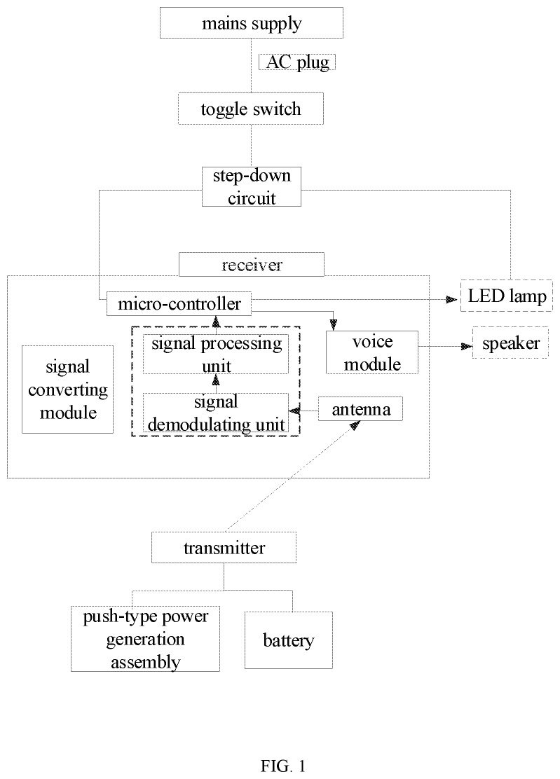

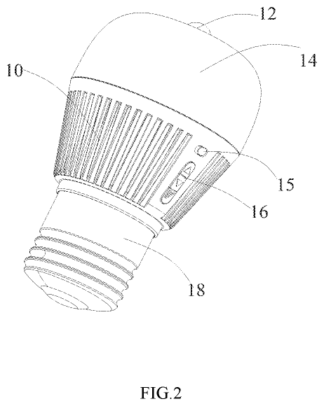

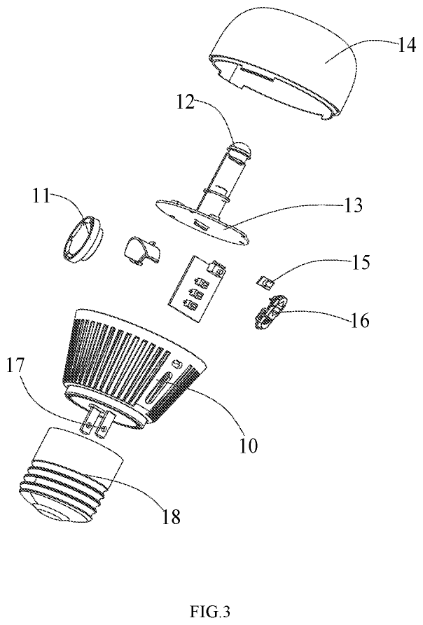

Referring to FIGS. 1 to 3, the present disclosure provides an alarm apparatus. The alarm apparatus includes a plurality of transmitters and at least one luminaire. Each transmitter is configured to detect an environment where the transmitter is located, and transmit a detecting signal. The lamp is internally provided with a speaker 11, a receiver, and a LED lamp 12. The speaker 11 and the LED lamp 12 are both electrically connected to the receiver, the receiver is configured to receive the detecting signal, the receiver is also configured to turn on or turn off of the LED lamp 12, and/or control the speaker 11 to raise an alarm. In detail, the receiver can be configured to turn on and turn off the LED lamp 12 periodically.

The transmitters can be respectively defined on the doorbell and the window, and defined in the kitchen and factory, etc. Each transmitter is configured to detect the environment where the transmitter is located, and emit the detecting signal. The transmitter may be one selected from a group consisting of a door magnet, a Passive Infra-Red (PIR) sensor, a smoke sensor, a leak detector, a gas detector, and an SOS emergency transmitter, etc. The luminaires can be respectively defined in the house or monitoring room. The luminaire is internally provided with the speaker 11, the receiver, and the LED lamp 12. The receiver is configured to receive the detecting signal. The transmitter can send out the detecting signal when some one triggers the transmitter on the doorbell or there is a gas leak. The receiver in the house or the monitoring room controls the luminaire to emit light with different colors, and/or turns on or turns off the luminaire, and/or controls the speaker 22 to issue the alarm, after the receiver receives the detecting signal sent by the transmitter. The alarm can be either a buzzing or a music. Therefore, the alarm apparatus of the present disclosure can meet the needs of different people. In detail, the deaf or some special people, i.e., people who can't hear the sound, can get the alarm through the changes of light. And the blind can get the alarm according to the alarm sound emitted from the speaker 11.

In a preferable embodiment, different songs can be set as different alarm categories, and different types of transmitters can be set in different positions. For example, the transmitter A is set on the doorbell, and the corresponding alarm is defines as song A for reminding person in the house or the monitoring room that there is a visitor outside the door. Transmitter B is set on the window (the transmitter B is an infrared body sensor), the corresponding alarm is defined as song B for indicating that there are creatures (such as, human or animal) coming in through the window. Transmitter C is set in the kitchen (transmitter C is gas detector), the corresponding alarm is defines as the buzzing for indicating a gas leakage inside the house.

In detail, the receiver includes a micro-controller electrically connected to the LED lamp, a signal receiving module, a signal converting module electrically connected to the micro-controller and the signal receiving module respectively, and a voice module electrically connected to the speaker 11 and the micro-controller, respectively. Based on the above structure, the signal receiving module is configured to receive the detecting signal sent by the transmitter and transmit the detecting signal to the signal converting module. The signal converting module is configured to convert the detecting signal into an electrical signal and transmit the electrical signal to the micro-controller. The micro-controller sends a voice control signal to the voice module after receiving the electrical signal. The micro-controller activates the speaker 11 to issue the alarm through the voice module, and simultaneously turns on or turns off the LED lamp 12.

In detail, the signal converting module includes a signal demodulating unit electrically connected to the signal receiving module, and a signal processing unit electrically connected to the signal demodulating unit and the micro-controller, respectively. Based on the above structure, the signal receiving module is configured to receive the detecting signal sent by the transmitter. Antenna or Bluetooth can be set in the signal receiving module. The received detecting signal is then transmitted to the signal demodulating unit. The signal demodulating unit is configured to demodulate the detecting signal, and transmit the demodulated detecting signal to the signal processing unit. The signal processing unit is configured to proofreading the demodulated detecting signal and output the electrical signal to the micro-controller.

Different transmitters may emit different detecting signals. For example, the detecting signals of the transmitters are respectively 2.4G band signal, 433.92 MHz band signal, 315 MHz band signal, 868 MHz and 915 MHz band signals, the detecting signals can be demodulated into different code IDs, and the micro-controller stores a plurality of pre-stored code IDs respectively matching with the code IDs of transmitters, and the code IDs can be matched with the corresponding pre-stored code IDs, for turning on or turning off the LED lamp 12, and/or controlling the speaker 11 to issue the alarm. Therefore, the phenomenon of wrong alarm is prevented.

In detail, the luminaire includes an upper housing 10, a control panel 13, and a lampshade 14. An end of the upper housing 10 defines an opening. The micro-controller, the voice module, the LED lamp 12, the signal receiving module, and the signal converting module are all encapsulated on the control panel 13. The lampshade 14 is disposed at a periphery of the opening of the upper housing 10, and the speaker 11 is defined in the upper housing 10. Based on the above structure, the speaker 11 is disposed inside the luminaire, that is, the speaker 11 is disposed in the upper casing 10, and the micro-controller, the voice module, the LED lamp 12, the signal receiving module, and the signal converting module are all encapsulated on the control panel 13, for optimizing the interior space of the luminaire. So that the illuminator can alarm under the premise of ensuring illumination function.

In detail, the luminaire further includes a toggle switch 15, which embedded in the upper housing 10, and the LED lamp 12 is connected to a mains supply through the toggle switch 15. The LED lamp 12 and/or the speaker 11 may generate a false alarm, when the component inside the luminaire breaks down. User can manually turn on or turn off the LED lamp 12 through the toggle switch 15 at any time. The mains supply of the present disclosure can be domestic mains, or foreign mains, which is not limited herein.

In detail, the luminaire further includes an adjusting button 16, which embedded in the upper housing, and the adjusting button 16 is electrically connected to the micro-controller. Based on the above structure, user can control the volume of the speaker 11 by adjusting the button 16, or can switch the playback mode of the speaker 11, such as switching songs, etc.

In detail, an Alternating Current (AC) plug 17 is embedded in an end of the upper housing 10 away from the lampshade 14, and the luminaire further includes a protecting cover 18 which is defined at the end of the upper housing 10 away from the lampshade 14 and covering the AC plug 17, the protective cover 18 is electrically connected to the AC plug 17. The AC plug 17 can be received in the protecting cover 18. Based on the above structure, the AC plug 17 can be directly connected with the mains supply, or the AC plug 17 can be embedded and connected to the lampholder through the protecting cover 18. As such, the alarm apparatus of the present disclosure much more functions.

In another exemplary embodiment, push-type power generation assembly and/or energy storage battery can be arranged in the transmitter, to ensure the normal operation of the transmitter.

In a further exemplary embodiment, a step-down transformer can be sealed in the upper housing 10, and the step-down transformer includes a step-down circuit. An input end of the step-down circuit is electrically connected to an end of the toggle switch 15, the other end of the toggle switch 15 is connected to the external mains supply. An output end of the step-down circuit is electrically connected to the micro-controller and the LED lamp respectively, for converting the mains electricity to the voltage for alarm operation.

The present disclosure further provides an alarm method, which includes: receiving an alarm signal sent by a transmitter in real time or periodically; and controlling on/off of a LED lamp 12, and/or controlling a speaker 11 to raise an alarm, according to the alarm signal.

In the exemplary embodiment, the transmitter may be one selected from a group consisting of a door magnet, a Passive Infra-Red (PIR) sensor, a smoke sensor, a leak detector, a gas detector, and an SOS emergency transmitter, etc.

The transmitters can be respectively defined on the doorbell, the window, or defined in the kitchen or factory. The luminaire can be arranged in the house or the monitoring room. The luminaire is internally provided with the receiver, micro-controller, LED lamp 12, and the speaker 11, etc. The transmitter can emit the alarm signal when triggered. The receiver of the luminaire turns on or turn off the LED lamp 12, and/or control the speaker 11 to raise the alarm, according to the alarm signal, after the luminaire receives the alarm signal.

In detail, before the operation of turning on or turning off of the LED lamp 12, and/or controlling the speaker 11 to raise the alarm, according to the alarm signal, the alarm method further includes: decoding an code ID according to the alarm signal; comparing the code ID with a preset code ID; and turning on or turning off of the LED lamp 12, and/or controlling the speaker 11 to raise the alarm, according to the alarm signal, when the code ID matches the preset code ID.

In the exemplary embodiment, the code ID is decoded according to the alarm signal. For example, the detecting signal sent by the transmitter is modulated into a modulation signal, in order to prevent the lamp from making a false alarm according to other detecting signal. And the modulation signal is sent to the receiver of the luminaire. after receiving the corresponding modulation signal, the receiver of the luminaire demodulates the modulation signal and outputs the coded ID. And the micro-controller has already stored the pre-stored code IDs respectively matching with the code IDs sent by the transmitters, and the micro-controller matches the demodulated code IDs with the pre-stored code IDs, for turning on or turning off the LED lamp 12, and/or controlling the speaker 11 to issue the alarm. Therefore, the phenomenon of wrong alarm is prevented

In a preferable embodiment, there are a plurality groups of transmitters, the alarm signals sent from the plurality groups of transmitters can be 2.4G band signal, 433.92 MHz band signal, 315 MHz band signal, 868 MHz and 915 MHz band signals, respectively. The micro-controller in the luminaire can store a plurality of pre-stored code IDs respectively matching with the plurality groups of transmitters in advance. The micro-controller can match the code IDs with corresponding pre-stored code IDs, for turning on or turning off the LED lamp 12, and/or controlling the speaker 11 to issue the alarm. Therefore, multiple scenes can be monitored in real time or at regular intervals, and the alarm apparatus is also suitable for many different types of people.

Specifically, a type of the alarm sound, and/or a color type of light, and/or a flashing frequency corresponding to the alarm signal, are acquired, according to a relationship between a type of a preset alarm signal and at least one parameter selected from a group consisting of the type of the alarm sound, the color type of light, and the flashing frequency, when the alarm signal is received. The speaker 11 is controlled to issue the alarm according to the type of the alarm sound, and/or the LED lamp 12 is controlled to flash according to the color type of light and/or the flashing frequency. Based on the above method,

after the luminaire receives the type of the alarm sound, and/or the color type of light, and/or the flashing frequency, the luminaire controls the speaker 11 to issue the alarm according to the type of the alarm sound, and/or the luminaire controls the LED lamp 12 to flash according to the color type of light, and/or the flashing frequency. For example, the luminaire can emit blue light, and the speaker 11 beeps simultaneously, for alerting the user.

The foregoing description merely depicts some preferred embodiments of the present disclosure and therefore is not intended to limit the scope of the present disclosure. An equivalent structural or flow changes made by using the content of the specification and drawings of the present disclosure, or any direct or indirect present disclosures of the disclosure on any other related fields shall all fall in the scope of the present disclosure.

1. An alarm apparatus, wherein, the alarm apparatus comprises:
a plurality of transmitters, each transmitter being configured to detect an environment where the transmitter is located, and transmit a detecting signal; and
at least one luminaire, comprising a receiver, and an LED lamp;
wherein the LED lamp is electrically connected to the receiver, the receiver is configured to receive the detecting signal and control on/off of the LED lamp according to a color type of light and/or a flashing frequency corresponding to the detecting signal.

2. The alarm apparatus according to claim 1, wherein the receiver comprises:
a micro-controller, electrically connected to the LED lamp;
a signal receiving module;
a signal converting module, electrically connected to the micro-controller and the signal receiving module, respectively; and
a voice module, electrically connected to the speaker and the micro-controller, respectively.

3. The alarm apparatus according to claim 2, wherein the signal converting module comprises:
a signal demodulating unit, electrically connected to the signal receiving module; and
a signal processing unit, electrically connected to the signal demodulating unit and the micro-controller, respectively.

4. The alarm apparatus according to claim 2, wherein the luminaire comprises:
an upper housing, an end of the upper housing defines an opening;
a control panel, the micro-controller, the voice module, the LED lamp, the signal receiving module, and the signal converting module are all encapsulated on the control panel; and
a lampshade, disposed at a periphery of the opening of the upper housing, and the speaker is defined in the upper housing.

5. The alarm apparatus according to claim 4, wherein the luminaire further comprises:
a toggle switch, embedded in the upper housing, and the LED lamp is connected to a mains supply through the toggle switch.

6. The alarm apparatus according to claim 4, wherein the luminaire further comprises:
an adjusting button embedded in the upper housing and electrically connected to the micro-controller.

7. The alarm apparatus according to claim 4, wherein an alternating current plug is embedded in an end of the upper housing away from the lampshade, and the luminaire further comprises:
a protecting cover, defined at the end of the upper housing away from the lampshade and covering the alternating current plug, the protective cover being electrically connected to the alternating current plug.

8. The alarm apparatus according to claim 1, wherein the transmitter is selected from a group consisting of a door magnet, a passive infra-red sensor, a smoke sensor, a leak detector, a gas detector, or an SOS emergency transmitter.

9. The alarm apparatus according to claim 2, wherein the transmitter is selected from a group consisting of a door magnet, a passive infra-red sensor, a smoke sensor, a leak detector, a gas detector, or an SOS emergency transmitter.

10. The alarm apparatus according to claim 3, wherein the transmitter is selected from a group consisting of a door magnet, a passive infra-red sensor, a smoke sensor, a leak detector, a gas detector, or an SOS emergency transmitter.

11. The alarm apparatus according to claim 4, wherein the transmitter is selected from a group consisting of a door magnet, a passive infra-red sensor, a smoke sensor, a leak detector, a gas detector, or an SOS emergency transmitter.

12. The alarm apparatus according to claim 5, wherein the transmitter is selected from a group consisting of a door magnet, a passive infra-red sensor, a smoke sensor, a leak detector, a gas detector, or an SOS emergency transmitter.

13. The alarm apparatus according to claim 6, wherein the transmitter is selected from a group consisting of a door magnet, a passive infra-red sensor, a smoke sensor, a leak detector, a gas detector, or an SOS emergency transmitter.

14. The alarm apparatus according to claim 7, wherein the transmitter is selected from a group consisting of a door magnet, a passive infra-red sensor, a smoke sensor, a leak detector, a gas detector, or an SOS emergency transmitter.

15. An alarm method, comprising:
receiving an alarm signal sent by a transmitter in real time or periodically; and
turning on or turning off of an LED lamp, according to the alarm signal,
wherein the operation of turning on or turning off of an LED lamp according to the alarm signal comprises:
acquiring a color type of light, and/or a flashing frequency corresponding to the alarm signal, according to a relationship between a type of a preset alarm signal and at least one parameter selected from a group consisting of the color type of light and the flashing frequency, when the alarm signal is received; and
controlling the LED lamp to flash according to the color type of light and/or the flashing frequency.

16. The alarm method according to claim 15, wherein before the operation of turning on or turning off of an LED lamp according to the alarm signal, the alarm method further comprises:
decoding a code ID according to the alarm signal;
comparing the code ID with a preset code ID; and
turning on or turning off of the LED lamp based on the alarm signal, when the code ID matches the preset code ID.

17. (canceled)

18. The alarm method according to claim 15, further comprising:
controlling a speaker to raise an alarm according to the alarm signal.

19. The alarm method according to claim 18, wherein the operation of controlling a speaker to raise an alarm according to the alarm signal comprises:
acquiring a type of an alarm sound corresponding to the alarm signal, according to a relationship between a type of a preset alarm signal and the alarm sound, when the alarm signal is received; and
controlling the speaker to raise the alarm according to the type of the alarm sound.

20. The alarm apparatus according to claim 1, wherein the at least one luminaire further comprises a speaker electrically connected to the receiver, and the receiver is further configured to control the speaker to raise an alarm according to a type of an alarm sound corresponding to the detecting signal.
